(19) United States
(12) Patent Application Publication
(10) Pub. No.: US 2016/0130185 A1
(43) Pub. Date: May 12, 2016

(54) BATCH FOR PRODUCING A CARBON-BONDED OR RESIN-BONDED SHAPED FIRE-RESISTANT PRODUCT, A METHOD FOR PRODUCING SUCH A PRODUCT, A PRODUCT OF SAID TYPE, AND A USE OF MAGNESIA SPINEL ZIRCONIUM OXIDE

(71) Applicant: REFRACTORY INTELLECTUAL PROPERTY GMBH & CO. KG, Wien (AT)

(72) Inventors: Mira-Annika Muller, Bleiberg-Kreuth (AT); Roland Nilica, Feistritz (AT); Martin Wiesel, Trofaiach (AT); Jurgen Muhlhausser, Leoben (AT); Renaud Grasset-Bourdel, St. Michael (AT)

(21) Appl. No.: 14/899,690

(22) PCT Filed: Jun. 27, 2014
(86) PCT No.: PCT/EP2014/063658

§ 371 Date: Dec. 18, 2015

(30) Foreign Application Priority Data
Sep. 12, 2013 (EP) 13184031.6

(51) Int. Cl. C04B 35/103

(52) U.S. Cl. CPC C04B 35/103; C04B 2235/3222; C04B 2235/5427; C04B 2235/3217

(57) ABSTRACT

The invention relates to a batch for producing a carbon-bonded or resin-bonded shaped fire-resistant product, a method for producing such a product, a product of said type, and a use of magnesia spinel zirconium oxide.

The invention relates to a batch for the production of a carbon-bonded or resin-bonded shaped refractory product, to a process for the production of a product of this type, to a product of this type as well as to the use of magnesia spinel-zirconium oxide.

Carbon-bonded and resin-bonded shaped refractory products are produced from a batch which comprises carbon-comprising components. When carbon-bonded products are produced from a batch of this type, the batch is heated to a temperature such that the carbon-comprising components carbonize and form a carbon microstructure into which the further components of the batch are firmly integrated. When a resin-bonded product is to be produced from a batch comprising a carbon-comprising component, at least one carbon-comprising component is present in the form of resin. This resin can self-cure or be cured using a hardener. After curing of the resin, a resin-bonded product is produced from the batch, in which the cured resin firmly binds the remaining components of the batch together and endows the product with a rigid structure.

Usually, both carbon-bonded and also resin-bonded products only produce the final carbon bonding when the respective product is placed in service at the prevailing operating temperatures thereof.

Examples of typical carbon-bonded or resin-bonded shaped refractory products are slide plates in steel strand casting systems. In steel strand casting systems, slide plates together with the metal housing surrounding it form a slide gate. Slide gates of this type in the form of ladle slide gates act to regulate the throughflow of the steel melt through the ladle shroud between the casting ladle and tundish, or in the form of tundish slide gates act to regulate the throughflow of the steel melt through the submerged nozzle between the tundish and mould.

In order to regulate the throughflow of steel grades with a highly corrosive ladle slag, alumina-based carbon-bonded or resin-bonded slide plates are used in particular. In order to increase the corrosion resistance of the slide plate as regards the highly corrosive ladle slag, the slide plate may contain quantities of zirconium corundum. Because of these quantities of zirconium corundum, slide plates of this type usually have a small proportion of silicic acid, whereupon the corrosion resistance of the slide plate is increased.

By increasing the proportion of zirconium corundum in slide plates of this type, the corrosion resistance of these plates can indeed be increased. However, the proportion of zirconium corundum cannot be increased ad infinitum, as the brittleness of the plates increases with an increasing content of zirconium corundum, whereupon the thermal shock resistance and thus the service life of the plates is reduced.

The object of the invention is to provide a batch by means of which a carbon-bonded or resin-bonded shaped refractory product, in particular in the form of a slide plate, can be produced with a high corrosion resistance, in particular as regards corrosive ladle slags used in steel strand casting. In particular, an object of the invention is to provide a batch of this type by means of which slide plates can be produced which exhibit improved corrosion resistance compared with carbon-bonded or resin-bonded slide plates of the prior art based on alumina and zirconium corundum.

A further object of the invention is to provide a process for the production of a carbon-bonded or resin-bonded shaped refractory product of this type from a batch of this type.

A further object of the invention is to provide a carbon-bonded or resin-bonded shaped refractory product of this type.

The first-mentioned object of the invention is accomplished by providing a batch for the production of a carbon-bonded or resin-bonded shaped refractory product, comprising the following components:
one or more alumina-comprising components;
one or more carbon-comprising components;
one or more antioxidants for suppressing oxidation of the carbon;
if appropriate, one or more further components;

characterized in that the batch further comprises
at least one component in the form of magnesia spinel-zirconium oxide.

The invention is based on the principle that the corrosion resistance of alumina-based carbon-bonded or resin-bonded shaped refractory products, in particular in the form of slide plates, as regards highly corrosive ladle slags can be improved when the batch for the production of products of this type comprises at least one component in the form of magnesia spinel-zirconium oxide.

The term “magnesia spinel-zirconium oxide” means a raw material which is formed from magnesia spinel (i.e. MA spinel, MgO.Al₂O₃) and zirconium oxide (i.e. zirconia, ZrO₂).

It has been inventively established that using magnesia spinel-zirconium oxide in batches for the production of carbon-bonded or resin-bonded shaped refractory products not only means that the corrosion resistance of the products can be improved, but also that their thermal shock resistance can be improved. In contrast to the use of zirconium corundum, using magnesia spinel-zirconium oxide means that the thermal shock resistance of the products is not compromised, but is improved.

The best values for the corrosion resistance and thermal shock resistance of the products produced from the batch of the invention were obtained when the magnesia spinel of the magnesia spinel-zirconium oxide in the batch of the invention was present in stoichiometric quantities, i.e. with a molar ratio of MgO to Al₂O₃ of 1:1. In accordance with the invention, then, in particular, the magnesia spinel of the magnesia spinel-zirconium oxide in the batch may be present in stoichiometric or essentially stoichiometric quantities i.e. with a maximum deviation, for example, of 10% or a maximum of 5% from the stoichiometric composition, i.e. with a molar ratio of MgO to Al₂O₃ in the range 1.1 to 0.9 or in the range 1.05 to 0.95. In a further development of this inventive concept, the deviation of the molar ratio from the stoichiometric composition may also be a maximum of only 4%, 3%, 2% or even only 1%. The magnesia spinel of the whole of the magnesia spinel-zirconium oxide of the batch may be present with this molar ratio of MgO to Al₂O₃. However, it may also be possible for part of the magnesia spinel to deviate from this molar ratio, for example in the edge regions of the magnesia spinel-zirconium oxide grains of the batch or the products produced therefrom.

The proportion of zirconium oxide in the magnesia spinel-zirconium oxide may, for example, be in the range 10% to 65% by weight with respect to the total weight of the magnesia spinel-zirconium oxide. In this regard, the proportion of zirconium oxide in the magnesia spinel-zirconium oxide may, for example, be at least 10%, 13%, 15%, 18%, 20%, 22%, 24%, 26%, 27%, 28% or 29% by weight. Furthermore, the proportion of zirconium oxide in the magnesia spinel-zirconium oxide may, for example, be at most 65% by weight including, for example, at most 60%, 55%, 50%, 45%, 42%, 40%, 38%, 36%, 34%, 33%, 32% or 31% by weight.

In known manner, zirconium oxide is regularly used in refractory products in a stabilized form, for example in a form stabilized with yttrium oxide. However, in accordance with the invention, the zirconium oxide in the magnesia spinel-zirconium oxide of the batch of the invention may preferably be in the unstabilized or only partially stabilized form.

Preferably, the magnesia spinel-zirconium oxide component of the batch of the invention is in the ultrapure form, i.e. as essentially pure magnesia spinel-zirconium oxide. Preferably, the magnesia spinel-zirconium oxide in the batch of the invention is in the form of fused raw material. The fused raw material may, for example, be obtained by melting the starting raw materials containing MgO, Al₂O₃ and ZrO₂ followed by cooling the melt. The melt can then be processed into a granular commodity and be used in this form in the batch of the invention. Particularly preferably, the magnesia spinel-zirconium oxide component in the batch of the invention is present in the form of melt grains of this type. A process for the production of a magnesia spinel-zirconium oxide fused raw material is described in U.S. Pat. No. 3,498,769, for example.

The magnesia spinel-zirconium oxide in the batch of the invention may, for example, be present in a proportion in the range 2% to 35% by weight with respect to the total weight of the batch. In this regard, the component in the form of magnesia spinel-zirconium oxide may, for example, be present in the batch of the invention in a proportion of at least 2% by weight including, for example, in a proportion of at least 4%, 6%, 8% or 10% by weight. Furthermore, magnesia spinel-zirconium oxide in the batch of the invention may be present, for example, in a proportion of at most 35% by weight including, for example, in a proportion of at most 32%, 30%, 28%, 27%, 26% or 25% by weight.

The magnesia spinel-zirconium oxide in the batch may have a relatively small grain size, for example a grain size of at most 3 mm including, for example, a grain size of at most 2.5 mm, 2 mm, 1.5 mm or 1.0 mm. Furthermore, the magnesia spinel-zirconium oxide in the batch may have a grain size of not less than 0.1 mm, including, for example, a grain size of not less than 0.2 or 0.3 mm.

The batch of the invention is based on alumina, i.e. Al₂O₃ or aluminium oxide or corundum.

The alumina-comprising components in the batch may be present in a proportion of 60% to 90% by weight with respect to the total weight of the batch. In this regard, the alumina-comprising components in the batch may, for example, be in a proportion of at least 60% by weight including, for example, in a proportion of at least 62%, 64%, 66%, 68%, 70%, 71%, 72%, 73% or 74% by weight.

Furthermore, the alumina-comprising components may, for example, be present in the batch in a proportion of at least 90% by weight including, for example, in a proportion of at most 88%, 86%, 84%, 82%, 80%, 79%, 78%, 77% or 76% by weight.

The alumina-comprising components may be present in the form of pure alumina or raw materials with a high alumina content, in particular with a proportion of alumina of more than 95%, 96%, 97%, 98% or 99% by weight with respect to the total weight of the alumina-comprising components.

As an example, the alumina-comprising components may be in the form of at least one of the following components: sintered corundum, fused corundum, brown corundum, hollow bead corundum, tabular aluminium oxide or calcined aluminium oxide. In accordance with a preferred embodiment, the alumina-comprising components are in the form of tabular aluminium oxide and calcined aluminium oxide.

In accordance with one embodiment, the alumina-comprising components are present in the batch in a grain size of at most 5 mm including, for example, in a grain size of at most 4 mm, 3 mm, 2.5 mm or 2 mm. It is possible for the alumina-comprising components in the batch to have the following ranges of proportions by weight respectively in the following grain size ranges, respectively with respect to the total weight of the batch:
>0.045 to 5 mm: 44% to 60% by weight;
>0 to 0.045 mm: 16% to 30% by weight.

Carbon-comprising components, i.e. carbon substrates, may be present in the batch in a proportion in the range 2% to 9% by weight with respect to the total weight of the batch. In this regard, the carbon-comprising components may, for example, be present in the batch in a proportion of at least 2% by weight, 2.5% by weight, 3% by weight, 3.5% by weight or 4% by weight. Furthermore, the carbon-comprising components may, for example, be present in the batch in a proportion of at most 9%, 8%, 7%, 6% or 5% by weight.

In principle, the carbon-comprising components may be present in the form of any components which are known in refractory technology which can introduce carbon for the production of carbon-bonding or resin-bonding into a refractory batch. As an example, the carbon-comprising components may be in the form of one or more of the following components in the batch: carbon black, petroleum coke, graphite or resin.

The carbon-comprising components serve to introduce carbon into the batch. Depending on the type of these components, in a first step they form either a carbon bond or a carbon binder matrix or a resin binder matrix. In a second step, usually when using the respective products and under the prevailing conditions of service, the respective matrices produce the final carbon bonding.

When a carbon-bonded product is to be produced, the batch is heated to a temperature at which the carbon-comprising component forms a carbon bond or a carbon binder matrix.

When the carbon is introduced into the batch in the form of resin, the resin is allowed to cure so that it forms a resin binder matrix and forms a resin-bonded product with the other components of the batch.

Resin as the carbon-comprising component in the batch may in particular be in the form of at least one synthetic resin, in particular in the form of at least one synthetic resin from the phenol-formaldehyde group. As an example, the resin may be in the form of at least one of the following synthetic resins: novolac or resol. As is known in the art, the resin in the batch may be present as a liquid or in the form of a powder.

The carbon-comprising components in the form of carbon black, petroleum coke, graphite in the batch may each be ground to flour fineness, in particular with a grain size of less than 0.05 mm, for example.

The batch may comprise at least one antioxidant in order to suppress oxidation of the carbon. Appropriate antioxidants thus suppress the oxidation of the carbon in the carbon-comprising components during service of a slide plate produced from the batch, so that the carbon in the carbon-comprising components does not oxidize.

In the prior art, it is known to add metallic silicon as an antioxidant to batches of this type based on alumina for the production of carbon-bonded or resin-bonded shaped refractory products. Metallic silicon in the batch not only acts as an antioxidant for the carbon, but may also form silicon carbide with the carbon, which increases the strength of the product produced from the batch.

In addition to metallic silicon as the antioxidant, the batch may comprise metallic aluminium or boron carbide as antioxidants.

In this regard, the invention may provide that the batch of the invention comprises both metallic silicon and also metallic aluminium as antioxidants to suppress oxidation of the carbon.

The total weight of the metallic silicon and metallic aluminium antioxidants in the batch may, for example, be in the range 2% to 10% by weight including, for example, at least 3% by weight, 3.5% by weight, 4% by weight or 4.5% by weight. The upper limit in this regard may, for example, be a total weight of 10%, 9%, 8%, 7% or 6% by weight. The weights given above are with respect to the proportions in the total weight of the batch.

Preferably, the metallic silicon and metallic aluminium are present in a grain size of less than 1 mm including, for example, in a grain size of less than 0.5 or 0.1 mm.

In accordance with the invention, it is possible for the batch of the invention, in addition to the components mentioned above, i.e. at least one alumina-comprising component, at least one carbon-comprising component, at least one antioxidant and at least one component in the form of magnesia spinel-zirconium oxide, to comprise one or more further components, but preferably in a total weight of less than 5% by weight with respect to the total weight of the batch including, for example, a total weight of less than 4%, 3%, 2% or 1% by weight.

Preferably, the batch has no or only a small proportion of zirconium corundum, since the presence of zirconium corundum in the batch might deteriorate the flexibility of a product produced from the batch. If the batch contains quantities of zirconium corundum, then in accordance with the invention, these quantities may be below 5% by weight with respect to the total weight of the batch including, for example, below 4%, 3%, 2% or 1% by weight.

In particular, when the carbon-comprising components are not in the form of resin, in order to be able to process the batch, in particular in order to provide sufficient strength to the green body following forming, the batch may be provided with a binder or a primary binder; in this regard, known prior art primary binder systems for carbon-containing batches may be used, in particular including, for example, binders based on resin or synthetic resin, for example novolac. Binders may be added to the batch in proportions in the range 3% to 5% by weight, for example, with the batch without the binder constituting 100% by weight.

If a resin-based primary binder is used, the batch may comprise a hardener to cross-link the resin; in this regard, known prior art hardeners for resin-based primary binders may be used.

When the carbon-comprising component is used in the form of a resin in order to produce a resin-bonded product from the batch, the batch may comprise a further component in the form of a hardener to cure the resin if the resin is not self-curing. In this regard, known prior art hardeners may be used. As an example, hexamethylenetetramine may be used as a hardener for novolac resins.

A further object of the invention is the provision of a process for the production of a carbon-bonded or resin-bonded shaped refractory product, which comprises the following steps:
providing a batch in accordance with the invention;
shaping the batch to form a green body;
carbonizing the green body to form a refractory carbon-bonded product or curing the green body to form a refractory resin-bonded product.

Prior to shaping, the batch may be mixed with a binder as described above and with a hardener if appropriate. Mixing the batch with the binder and the hardener may, for example, be carried out in a compulsory mixer.

The batch may be shaped by compression, in particular uniaxial compression. The batch is shaped by the compression into a shaped unfired green body.

After shaping the batch into a green body, it is then handled in different manners depending on whether a carbon-bonded or resin-bonded product is to be produced from the batch and on the associated differing composition of the batch.

In order to produce a carbon-bonded product from the batch, the green body is then carbonized in a reducing atmosphere, whereupon carbon bonding or a carbon binder matrix is formed. Carbonizing may, for example, be carried out at temperatures in the range 1000° C. to 1400° C.

In order to produce a resin-bonded product from the batch, the resin in the green body is allowed to cure. Curing of the resin can usually be accelerated by increasing the temperature to which the green body is exposed, for example in the range 100° C. to 400° C.

Preferably, the batch of the invention is used for the production of slide plates for plant for the strand casting of steel. In this manner, the batch may be used both for the production of tundish slide plates and also for the production of ladle slide plates.

When slide plates are to be produced from the batch, the green body of the process of the invention is the green body for a slide plate which is carbonized to form a slide plate for a tundish or ladle slide gate for a strand casting system.

A further object of the invention is to provide a carbon-bonded or resin-bonded refractory product which is produced by means of a process in accordance with the invention.

As discussed above, a product of this type may in particular be a slide plate. A product in accordance with the invention in the form of a slide plate may, as is known in the art, be pitch impregnated before it is used. Thus, the object of the invention is a pitch impregnated slide plate of this type.

From a chemical viewpoint, a product in accordance with the invention is in particular characterized by the high magnesium oxide (MgO) content compared with prior art products of the same type. This magnesium oxide content is introduced into the batch of the invention by means of the magnesia spinel-zirconium oxide and thus into the product produced from the batch of the invention. Typically, the proportion of magnesium oxide in batches of the invention and in the products produced therefrom is in the range 1.5% to 6% by weight, in particular in the range 2% to 5% or 2% to 4% by weight. In contrast, typical proportions of magnesium oxide in prior art batches and products are less than 1% by weight, also including less than 0.5% by weight.

The microstructure of a carbon-bonded product of the invention is characterized by a carbon or coke binder matrix in which alumina and magnesia spinel-zirconium oxide are bonded as major phases. In addition, minor phases may be present, for example silicon and silicon carbide, aluminium and aluminium carbide, boron carbide, possible other minor phases as well as reaction products from these major and minor phases.

The microstructure of a resin-bonded product in accordance with the invention is characterized by a cured resin binder matrix into which alumina and magnesia spinel-zirconium oxide are integrated as major phases. The minor phases mentioned above may additionally be present.

When using the products of the invention and at the operating temperatures which prevail, the coke binder matrix or the resin binder matrix forms a “true” carbon binder matrix in the form of a rigid microstructure into which the major and minor phases mentioned above are integrated.

As discussed above, the products in accordance with the invention produced from the batch in accordance with the invention are characterized by excellent refractory properties.

Table 1 below shows ranges of values for possible refractory or physical properties of products in accordance with the invention.

TABLE 1

| | Range of |
|---|---|
| Physical property | values |
| Bulk density [g/cm³] | 2.95-3.05 |
| Porosity [% by volume] | 11.0-12.5 |
| Dynamic modulus of elasticity at room | 60-68 |
| temperature | |
| (sound propagation measurement) [GPa] | |
| Dynamic modulus of elasticity at 1400° C. in | 64-72 |
| reducing atmosphere | |
| (sound propagation measurement) [GPa] | |
| Hot bending strength at 1400° C. in reducing | 14-16 |
| atmosphere [MPa] | |
| Breaking strength Gf at 1400° C. in reducing | 220-280 |
| atmosphere [J/m²] | |
| Nominal notched bar tensile strength σNT at | 5.5-6.3 |
| 1400° C. in reducing atmosphere [MPa] | |
| Characteristic length at 1400° C. in reducing | 460-500 |
| atmosphere [mm] | |
| Kingery thermal shock parameter R at 1400° C. [K] | 7.5-8.5 |
| Hasselmann thermal shock parameter Rst at | 3.5-4.5 |
| 1400° C. [Km^{1/2}] | |

The above physical properties were determined in accordance with the following standards or methods:

Bulk density and porosity in accordance with DIN 993-1:1995.

Dynamic modulus of elasticity in accordance with DIN 51942:2002.

Hot bending strength in accordance with DIN EN 993-7:1998.

Breaking strength, characteristic length and nominal notched bar tensile strength in accordance with the details given in the following reference, wherein the measurements were carried out at 1100° C.: Harmuth H, Manhart Ch, Auer Th, Gruber D: “Fracture Mechanical Characterisation of Refractories and Application for Assessment and Simulation of the Thermal Shock Behaviour”, CFI Ceramic Forum International, Vol 84, No 9, pp E80-E86 (2007).

The Kingery thermal shock parameter R was measured in accordance with the details given in the following reference: Kingery W D: “Factors Affecting Thermal Stress Resistance of Ceramics Materials”, J Am Ceram Soc, 1955; 38(1): 3-15.

The Hasselmann thermal shock parameter Rst was measured in accordance with the following reference: Hasselmann D P H: “Unified Theory of Thermal Shock Fracture Initiation and Crack Propagation in Brittle Ceramics”, J Am Ceram Soc 1969; 52(11): 600-04.

Furthermore, the products in accordance with the invention are characterized by high strengths when carrying out the wedge splitting test. Graphs produced when carrying out the wedge splitting test on exemplary embodiments of the products of the invention as well as a comparative example of a prior art product are explained in more detail in the following description of exemplary embodiments of the invention.

The wedge splitting test was carried out in accordance with the reference given above in CFI Ceramic Forum International, Vol 84, No 9, pp E80-E86 (2007).

A further object of the invention is the provision of a carbon-bonded or resin-bonded shaped refractory product which comprises at least one of the physical properties within the respective range given in Table 1.

Finally, the subject matter of the invention pertains to the use of magnesia spinel-zirconium oxide in a batch based on alumina for the production of carbon-bonded or resin-bonded slide plates for a steel strand casting system.

A proviso to its use is that the batch is assembled in accordance with the invention and that the process of the invention is carried out.

Two example batches V1 and V2 are shown in Table 2 below, wherein example batch V1 is a prior art batch and batch V2 is an example batch in accordance with the invention in the form of a batch for the production of a carbon-bonded product.

TABLE 2

| Raw material | V1 | V2 |
|---|---|---|
| Tabular aluminium oxide >0.045-2.0 mm | 50 | 50 |
| zirconium corundum 0.3-1.0 mm | 15 | — |
| magnesia spinel-zirconium oxide 0.3-1.0 mm | — | 15 |
| Tabular aluminium oxide >0.0-0.045 mm | 25 | 25 |
| Antioxidants | 6 | 6 |
| Carbon substrate | 4 | 4 |

The data regarding batches V1 and V2 are given as a % by weight of the raw material in row 1, respectively with respect to the total weight of the respective batch.

The non-inventive batch V1 as well as the inventive batch V2 were then treated in accordance with the process of the invention. In this regard, batches V1 and V2 were initially mixed with 4.4% by weight of binder in the form of a resin, with 100% by weight being constituted by the respective batch without this binder, in a compulsory mixer and then shaped into a green body by uniaxial compression. The respective green body was in the shape of a slide plate to be produced therefrom.

Finally, the green body was carbonized at 1200° C. to form a refractory carbon-bonded product in the form of a slide plate.

Table 3 below shows the physical properties of the slide plates produced thereby, wherein the slide plate produced from the non-inventive batch V1 is denoted S1 and the slide plate produced from the inventive batch V2 is denoted S2.

TABLE 3

| Physical property | S1 | S2 |
|---|---|---|
| Bulk density [g/cm³] | 3.02 | 3.0 |
| Porosity [% by volume] | 12.7 | 11.7 |
| Dynamic modulus of elasticity at room | 69 | 64 |
| temperature | | |
| (sound propagation measurement) [GPa] | | |
| Dynamic modulus of elasticity at 1400° C. in | 82 | 68 |
| reducing atmosphere | | |
| (sound propagation measurement) [GPa] | | |
| Breaking strength Gf at 1400° C. in reducing | 186 | 250 |
| atmosphere [J/m²] | | |
| Nominal notched bar tensile strength σNT at | 5.9 | 5.9 |
| 1400° C. in reducing atmosphere [MPa] | | |
| Characteristic length [mm] | 433.4 | 485.6 |
| Kingery thermal shock parameter Rst at 1400° C. | 6.9 | 7.9 |
| [K] | | |
| Hasselmann thermal shock parameter Rst at | 3.2 | 3.9 |
| 1400° C. [Km^{1/2}] | | |

The chemical analysis of the slide plates S1 and S2 is shown in Table 4 below.

TABLE 4

| Oxide | S1 | S2 |
|---|---|---|
| MgO | 0.2 | 3.0 |
| Al₂O₃ | 86.0 | 81.8 |
| SiO₂ | 9.7 | 9.9 |
| ZrO₂ | 3.8 | 4.8 |
| Remainder | 0.3 | 0.5 |

Again, Table 4 shows the proportions of the oxides as a % by weight with respect to the total weight of the respective product.

In order to investigate the corrosion resistance of the refractory products which could be produced from batches V1 and V2, brick segments were produced from batches V1 and V2 in accordance with the exemplary embodiment concerning the production of the slide plates S1 and S2, namely brick segment F1 from batch V1 and brick segment F2 from batch V2. These brick segments F1 and F2 were used as a part of a furnace lining on which a corrosion test was carried out in accordance with the so-called “induction crucible furnace test” (ITO test): initially, a furnace was built with a refractory lining wall formed from brick segments. In the subsequent slag zone, the lining was formed from the brick segments F1 and F2. The refractory lining enclosed a cylindrical furnace chamber into which a suitable cylindrical metallic charge (60 kg of steel) was placed. The metallic charge was heated to 1600° C. and melted by coils which encircled the lining. Powdered slag (3 kg with the chemical composition of Table 5) was added to the steel melt and fused to form a slag zone with a corrosive slag. The slag reacted in this slag zone with the brick segments F1 and F2 and damaged them corrosively thereby. The brick segments were corroded by the slag for a total of about 5 hours; the slag was refreshed approximately every hour. Next, the lining was removed and the degree of corrosion of the brick segments F1 and F2 were tested, namely the wear depth and the wear area.

TABLE 5

| | Proportion in the slag [% by |
|---|---|
| | weight with respect to the |
| Slag component | total weight of the slag] |
| CaO | 37.6 |
| MgO | 4.2 |
| MnO | 11.1 |
| Al₂O₃ | 10.0 |
| SiO₂ | 10.1 |
| Fe₂O₃ | 26.1 |
| F | 0.5 |
| S | 0.4 |

Table 6 shows the results of this corrosion test. In it, the measured wear area and wear depth of the brick segments F1, normalized to 100% are shown and set in relationship to the corresponding values for the brick segments F2. The wear area is the maximum cross sectional area of the corroded zones, while the wear depth is the maximum wear depth of the corroded zones. As can be seen from the values in Table 6, the wear of the brick segments F2 in accordance with the invention is only 62% of the wear area and only 80% of the wear depth of the brick segments F1 of the prior art.

TABLE 6

| Parameter | F1 | F2 |
|---|---|---|
| Normalized wear | 100% | 62% |
| area | | |
| Normalized wear | 100% | 80% |
| depth | | |

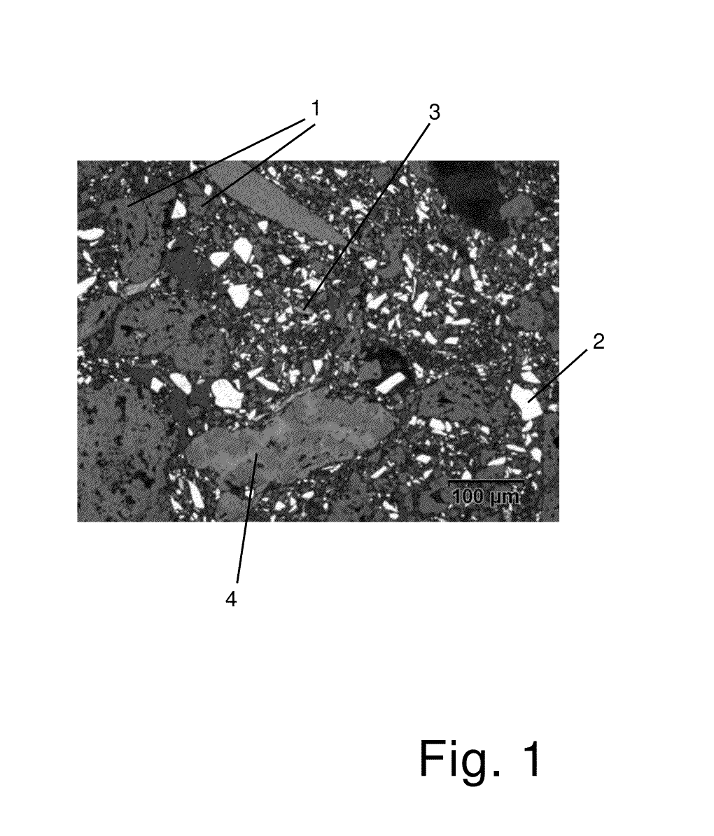

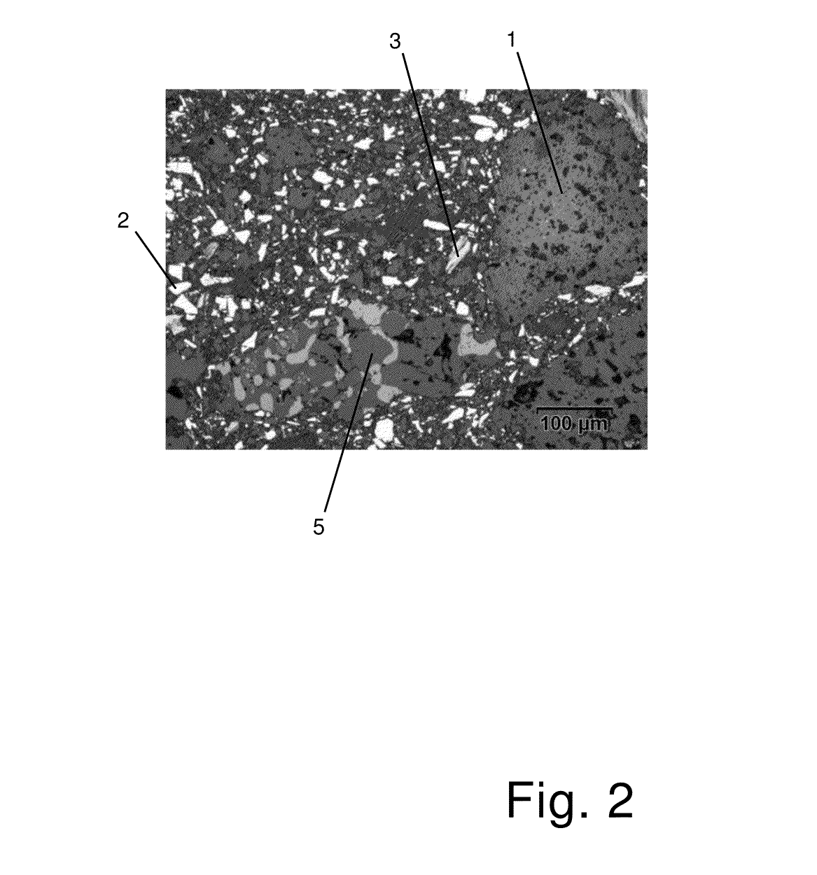

In the accompanying figures, FIGS. 1 to 2 show microsections of the slide plates S1 and S2. The black bars at the bottom right hand side of the figures each correspond to a length of 100 μm.

FIG. 1 shows the microsection of the slide plate S1 of the prior art. The tabular aluminium oxide (1), antioxidant (2) and carbon substrate (3) phases can be seen. In addition, zirconium corundum constitutes a further phase (4).

FIG. 2 shows the microsection of the exemplary embodiment of the slide plate of the invention S2. Again, the tabular aluminium oxide (1), antioxidant (2) and the carbon substrate (3) phases can be seen. In addition, magnesia spinel-zirconium oxide (5) can be seen as a further phase.

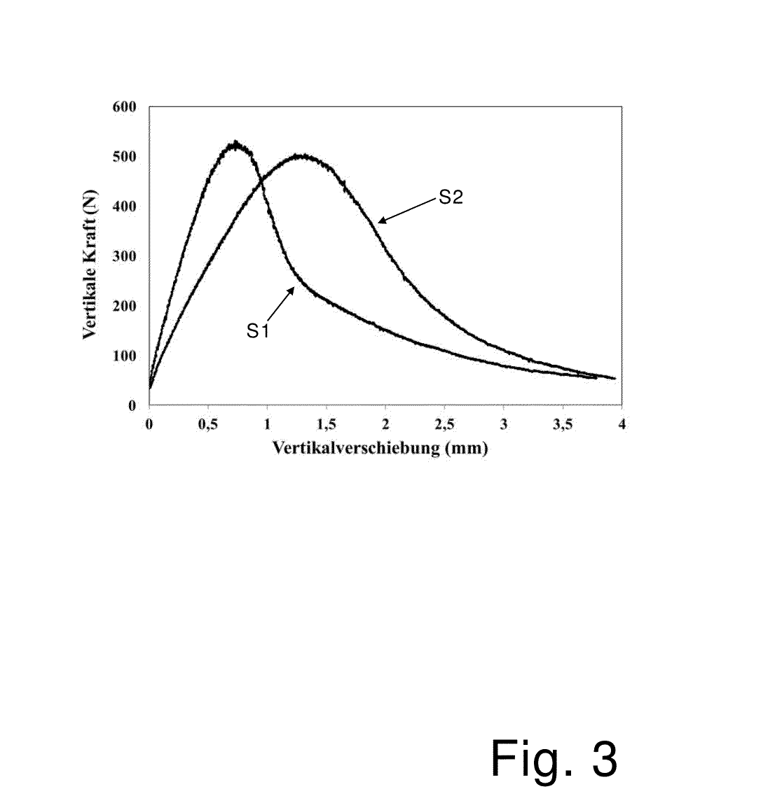

Finally, FIG. 3 shows profiles obtained during the wedge splitting test carried out on products S1 and S2. The wedge splitting tests were carried out at 1400° C. under reducing conditions.

In this regard, FIG. 3 shows the profile for the wedge splitting test carried out on the slide plate S1 at S1 and the profile for the wedge splitting test carried out on the slide plate S2 at S2. The wedge splitting tests were carried out at 1400° C. in a reducing atmosphere. For both slide plates S1 and S2, it can be seen that the maximum vertical force measured was approximately 500 N. However, the measured breaking strength, represented by the area under the respective curve, for the slide plate S2 in accordance with the invention is much larger than with the slide plate S1, and also the horizontal position of the maximum force for S2 is larger than that for S1. Because of the higher breaking strength and the larger horizontal position of the maximum force, slide plate S2 has substantially higher flexibility compared with that of slide plate S1.

1-12. (canceled)

13. A batch comprising:
at least one component comprising alumina,
at least one component comprising carbon,
at least one antioxidant for suppressing oxidation of carbon,
at least one component in the form of magnesia spinel-zirconium oxide being present as fused raw material,
wherein the batch is usable to produce a resin-bonded or carbon-bonded shaped refractory product.

14. The batch according to claim 13
wherein the magnesia spinel-zirconium oxide is present in the batch in a range from 2% to 35% by weight.

15. The batch according to claim 13
wherein the magnesia spinel of the magnesia spinel-zirconium oxide is present in a stoichiometric quantity.

16. The batch according to claim 13
wherein a proportion of zirconium oxide in the magnesia spinel-zirconium oxide is from 10% to 65% by weight.

17. The batch according to claim 13
wherein the magnesia spinel-zirconium oxide has a grain size that does not exceed 3.0 mm.

18. The batch according to claim 13
wherein the at least one component comprising alumina is present in the batch in a range from 60% to 90% by weight.

19. The batch according to claim 13
wherein the at least one component comprising carbon is present in the batch in a range from 2% to 9% by weight.

20. The batch according to claim 13
wherein the at least one antioxidant includes at least one of
metallic silicon,
metallic aluminum, or
boron carbide.

21. The batch according to claim 13
wherein the batch is usable to produce at least one of a carbon-bonded or resin-bonded slide plate for a steel strand casting system.

22. A process comprising:
(a) providing a batch including:
at least one component comprising alumina,
at least one component comprising carbon,
at least one antioxidant for suppressing oxidation of carbon,
at least one component in the form of magnesia spinel-zirconium oxide being present as fused raw material,
(b) shaping the batch to form a green body,
(c) subsequent to (b) either
(i) carbonizing the green body to form a refractory carbon-bonded product, or
(ii) curing the green body to form a refractory resin-bonded product.

23. The process according to claim 22
wherein the product formed in (c)(i) or (c)(ii) comprises a slide plate for a steel strand casting system.

24. An article produced by a process comprising:
(a) providing a batch including:
at least one component comprising alumina,
at least one component comprising carbon,
at least one antioxidant for suppressing oxidation of carbon,
at least one component in the form of magnesia spinel-zirconium oxide being present as fused raw material,
(b) shaping the batch to form a green body,
(c) subsequent to (b) either
(i) carbonizing the green body to form a refractory carbon-bonded product article, or
(ii) curing the green body to form a refractory resin-bonded product article.

25. The article according to claim 24
wherein the product article in (c)(i) or (c)(ii) comprises a slide plate for a steel strand casting system.

26. An article comprising:
a slide plate for a steel strand casting system, wherein the slide plate comprises:
a resin-bonded or carbon-bonded material,
wherein the material includes alumina and fused raw magnesia spinel-zirconium oxide.

27. An article made by a process, comprising:
(a) producing a material batch including alumina and fused raw magnesia spinel-zirconium oxide,
(b) forming from at least a portion of the batch, a green body of a slide plate for a steel strand casting system,
(c) at least one of
(i) carbonizing the green body to form a refractory carbon-bonded slide plate, or
(ii) curing the green body to form a refractory resin-bonded slide plate.
